(19) United States
(12) Patent Application Publication
(10) Pub. No.: US 2026/0104793 A1
(43) Pub. Date: Apr. 16, 2026

(54) PREDICTIVE HISTORY-BASED STREAM MANAGEMENT FOR TIERED STREAMING STORAGE SYSTEMS

(71) Applicant: Dell Products L.P., Round Rock, TX (US)

(72) Inventor: Raúl Gracia-Tinedo, Barcelona (ES)

(21) Appl. No.: 18/915,628

(22) Filed: Oct. 15, 2024

(51) Int. Cl. G06F 3/06; G06N 5/022

(52) U.S. Cl. CPC G06F 3/0604; G06F 3/0655; G06F 3/067; G06N 5/022

(57) ABSTRACT

Predictive streaming management operations are disclosed. A operations management system may include a model and an awareness queue that are configured to couple with a streaming storage system. A request to perform a streaming management operation in the streaming storage system may be accompanied with an indicator that, when set, causes the request to be placed in an awareness queue. Requests in the awareness queue are processed when a trained model predicts that the workload or usage of the streaming storage system is low. If the indicator is not set, the request is placed in a different queue and executed immediately or as soon as retrieved from the queue.

### TECHNOLOGICAL FIELD OF THE DISCLOSURE

Embodiments disclosed herein generally relate to stream management for tiered streaming storage systems. More particularly, at least some embodiments relate to systems, hardware, software, computer-readable media, and methods for predictive stream management for tiered storage systems.

### BACKGROUND

Streaming storage systems (or services) are becoming increasingly popular and are often used to manage and store data events in different scenarios including Internet of Things (IoT), telecommunications, and/or edge systems. Streaming storage systems allow events to be written with low latency and allow read events back both in real-time and in batch for processing. Most existing streaming storage systems provide users with ways to reliably store data in durable media (i.e., hard drives, nonvolatile memory express (NVMe) storage). These systems, however, do not provide a tiered storage layout. Even in scenarios where tiered storage is available, performing management operations usually impacts the primary functions of the streaming storage systems, which includes ingesting and storing data.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a multiple tier streaming storage system;

FIG. 2 discloses aspects of additional aspects of a multiple tier storage system with prediction-based stream management;

FIG. 3 discloses aspects of a method for performing streaming management operations in a streaming storage system; and

FIG. 4 discloses aspects of a computing device, computing system, or entity.

### DETAILED DESCRIPTION OF SOME EXAMPLE EMBODIMENTS

Embodiments disclosed herein generally relate to stream management in tiered storage systems. More particularly, at least some embodiments relate to systems, hardware, software, computer-readable media, and methods for predictive stream management for storage systems configured for storing streamed data.

Embodiments of the invention relate to efficiently performing stream management operations in the context of storing events or data (e.g., streaming data) in different storage tiers and to reducing the impact of stream (or data) management operations on current ingestion/storing workloads. In addition to performing stream management operations across a large amount of data stored in long-term-storage, other challenges include reducing the impact of data management operations in current ingestion workloads.

Tiered storage can take different forms and embodiments of the invention can adapt to different tiered storage configurations. In one example of tiered storage, recent data may be stored for a short period of time in a low latency, high performance storage (e.g., a write-ahead log (WAL)), while least recent data is moved to a long-term storage. This tiered arrangement facilitates high throughput, cost effectiveness, and parallelism. Multiple streams may be written and managed in parallel.

To efficiently manage streaming data in multiple storage tiers, historical workload patterns, including recent workload patterns, may be tracked over time. Using historical workload patterns, which may be related to user activity, embodiments of the invention may predict near term or future workload activity. More specifically, historical workload data may allow a model to learn daily workload patterns, weekly workload patterns, or the like, or combinations thereof. The historical workload data may include telemetry of the streaming storage system from a from various perspectives. Further, the telemetry data may be represented as time-series data. Example telemetry data may include, from a system perspective, used bandwidth, free bandwidth, process availability, or the like. Storage nodes may provide telemetry related to disk usage. Memory or cache levels may also be provided.

The telemetry data allows a model to learn patterns. When new telemetry data is available, workload peaks and/or valleys can be predicted. Advantageously, stream management operations can be scheduled to be performed during predicted workload valleys (periods of time of comparatively lower workload activity).

Embodiments of the invention may augment a streaming storage system with a stream management system that includes a machine learning model (or process) that was trained with historical workload patterns (e.g., via Long Short-Term Memory method, LSTM). The trained model helps the stream management system predict future workload valleys and execute stream management operations in periods of time where the ingestion workload is expected to be low or comparatively lower.

In addition, embodiments of the invention relate to stream policies that allow users to explicitly instruct the system to execute stream operations when the system predicts that the workload will be low to reduce or minimize the impact of data management operations on data ingestion performance. For example, a policy may be to truncate a stream to keep the last 1 GB (Gigabyte) of data, but run the truncation operation only during workload valleys.

Embodiments of the invention thus relate to systems for managing streams in a manner that schedules the management operations during periods of time in which the workload is expected or predicted to be low. More specifically, embodiments relate to optimizing or performing data management in tiered storage systems in a predictive manner that relies on historical workload patterns.

Embodiments of the invention are discussed in the context of streaming storage systems where data is stored in a tiered storage system and stream management operations (e.g., delete, truncate, update metadata) may act on potentially large datasets. In one example, the system may include client modules that operate on clients and a server module that operates on a server (or cluster or other configuration) in an edge, the cloud, or the like. The client modules perform reads and writes against a server through a communication channel (e.g., wired and/or wireless network, the Internet, cellular network). The server module handles client requests, data aggregation, and data storage.

By configurating a management system to perform management operations when workloads are expected to be low, the performance of the streaming storage system for data ingestion and/or storing operations is not impacted or is impacted less. The management system further provides policy based functionality such that users can configure their streams to allow the system executing stream management operations to be performed predictively based on workload patterns.

In one example, stream management operations, such as delete, truncate, and delete operations, may induce or cause IO (Input/Output) with respect to long term storage. The IO induced or caused by stream management operations may impact performance of the stream storage system at least with respect to data ingestion/storage workloads. A stream storage system is augmented or associated with artificial intelligence/machine learning (AI/ML) that uses telemetry such as workload metrics. With historical workload telemetry, the model may be trained to predict upcoming workload patterns. The workload patterns predicted by the model may include workload peaks (relatively heavier use) and workload valleys (relative lower use). Predicting the valleys allows the stream management operations to be performed during the valleys.

In one example, stream management operations may be queued for execution. The queue (or multiple queues) may be divided into operations related to streams that should be immediately served and operations that can be scheduled to be executed on workload valleys. This functionality may also be exposed to users such that the stream management operations can be configured for execution on workload valleys in a per stream basis.

A streaming management system may thus be configured to predictively execute stream management operations in stream storage systems. The streaming management system may be embedded as a module or component that does not require high integration or high coupling with the streaming storage system itself. This allows the streaming management system to operate with various types of streaming storage services, such as Pravega, Kafka, and Pulsar. Stated differently, embodiments of the invention include embedding AI/ML with streaming storage systems that perform dynamic workloads to facilitate more efficient streaming management operations.

By way of example and not limitation, a data stream is a continuous and unbounded data flow generated by one or more data sources. Common data streaming scenarios or environments include IoT (Internet of Things), sensors, telecommunications, edge scenarios, and the like. In one example, a stream is unbounded, append-only, and a durable sequence of bytes that guarantees strong consistency and good performance.

In one example, the streaming storage system for storing streaming data is a cloud-native infrastructure. The streaming storage system may present a software-defined storage architecture formed by controller instances (a control plane) and segment store instances (data plane).

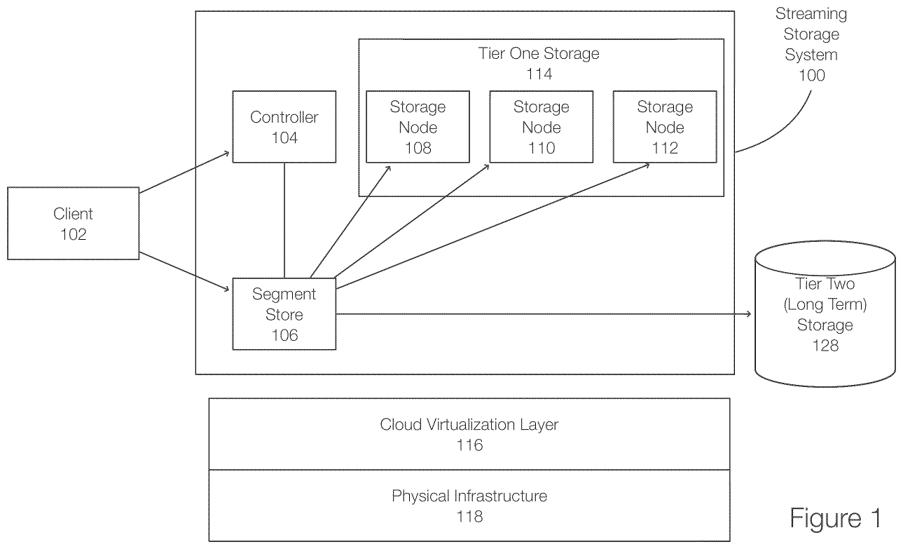

FIG. 1 discloses aspects of a streaming storage system that includes tiered storage. In this example, the streaming storage system 100 includes a controller 104 configured to perform or orchestrate stream management operations. The streaming storage system 100 may be implemented on physical infrastructure 118 via a cloud virtualization layer 116.

The streaming storage system 100 includes multiple storage tiers, represented by tier 1 (one) storage 114 and tier 2 (two) storage 128. The tier two storage 128 is an example of long term storage and may or may not be integrated with the streaming storage system 100. Thus, the tier two storage 128 may be provided by another storage service.

The tier one storage 114 may include storage nodes, represented by storage nodes 108, 110, and 112. The tier one storage 114 is typically configured in the streaming storage system 100 for storing recent data received from clients such as the client 102. The data being ingested is typically stored in the tier one storage 114 initially and is later moved to the tier two storage 128 when possible.

In this example, the tier one storage 114 provides short term, low latency storage and may guarantee the durability of data written to streams. The tier two storage 128 provides long term storage for the stream data. Storing stream data using tiered storage flows latency and throughput to be balanced.

In this example, stream data (e.g., events at the client 102) received from the client 102 may be handled by a segment store 106, which uses the storage nodes 108, 110, and 112. Metadata requests with respect to the client 102 may be handled by a controller 104. Thus, the controller 104 represents a control plane and the segment store 106 represents a data plane in the system 100.

In this example, data is generated at client 102. More specifically, the data generated at or by the client 102 may be viewed as streaming data. The streaming data is received via the segment store 106 and stored, at least in the short term, in the tier one storage 114. Data is moved to the tier two storage 128 for long term storage when possible. The segment store 106 may distribute data to different storage nodes based on the stream, load balancing, or the like.

In this example, the controller 104 is also configured to perform management operations or may be associated with a module configured to predictively perform or orchestrate data management operations. For certain data, the controller 104 may only perform stream management operations during times when the usage of the streaming storage system 100 is expected to be low.

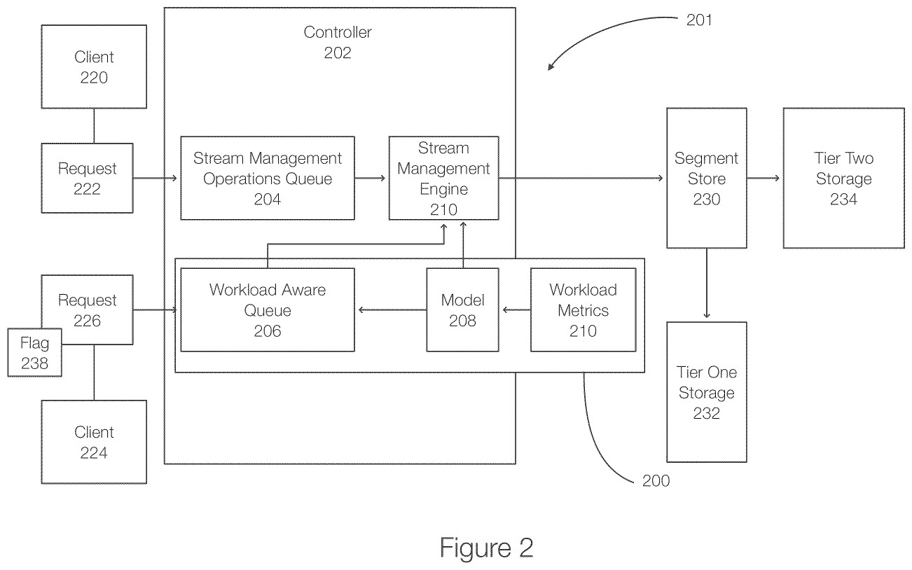

FIG. 2 discloses aspects of additional aspects of a multiple tier streaming storage system with prediction-based stream management. FIG. 2 illustrates aspects of a stream management system 200 that may be integrated with a streaming storage system 201 in a modular or component manner. FIG. 2 illustrates a controller 202 that includes or manages a stream management operations queue 204 and a workload aware stream management operations queue (workload aware queue) 206, which is part of the stream management system 200.

The operation of the stream management operations queue 204 is described in the context of a request 222 from a client 220. In this example, the request 222 is a delete request. More specifically, the client 220 issues a request for a delete operation for stream A. The request 222 is received at the controller 202 and the request 222 is persistently queued in the operations queue 204. The request 222 may also be acknowledged and the acknowledgment may be received by the client 220.

The stream management engine 210 retrieves the request 222 from the queue 204. The stream management engine 210 initially processes the metadata associated with the request 222 to identify the segments associated with the stream A that are targeted for deletion. Once the segments to be deleted are determined or identified, the stream management engine 210 may issue parallel segment delete operations against or to the segment store 230.

Initially, the segment store 230 persists the processing of these operations in the tier one storage 232. If there is a failure or crash, the system 200, or more specifically the stream management engine 210, can resume operation in a consistent manner. The segment store 230 may also issue or perform the delete operation with respect to the tier two storage 234 in parallel to delete all segments associated to the stream A. In parallel, the controller 202 also deletes metadata associated to the stream A.

When executing stream management operations on streams with large amounts of data, the execution of these operations may generate a burst of storage operations and activities in the streaming storage system 201. This activity may impact normal data ingestion operations performed by the system 201.

The workload aware queue 206 is configured to implement policies or cause the data management operations to be performed based on predicted behavior of the streaming storage system 201. In one example, the request 226 may include a flag 238 such that the request 226 is directed to the workload aware queue 206. The flag 238 causes or directs the controller 202 to perform stream management operations in a predictive manner. Thus, the request 226 is directed to the workload aware queue 206 of the control plane.

Because the request 226 is placed in the workload aware queue 206, the controller 202 (or stream management engine 210) performs the operations included in the request 226 at a predicted time, for example when workload of the system 201 is expected to be low. In this example, a model 208 is embedded or associated to the system 200. The model 208, which may be a time series prediction model, receives historical workload metrics 210 during training learns typical workload patterns in the system 201 (e.g., daily or weekly patterns). These patterns may be based on metrics such as data transfer rates, data transfer amounts, storage metrics (read rates, write rates), network usage, or the like.

During operation, the model 208 may receive current (or recent) workload metrics 210 and generate a prediction. In particular, the model 208 may generate a prediction that includes expected workload for a next period of time. The next period of time may be measured in hours, days, weeks, or the like.

Based on the prediction generated by the model 208, the stream management engine 210 may retrieve a corresponding request from the workload aware queue 206 and execute the request at the predicted time. Thus, the time at which the execution is dictated to correspond to times when workload is predicted to be low, which may differ from actual conditions. Advantageously, the performance or execution of data management operations for requests in the workload aware queue 206 does not impact or reduces the impact of the data management operations on the performance of normal ingestion or storage operations.

In another example, the operations queue 204 and the workload aware queue 206 may be combined into a single queue and the corresponding management operations are performed based on whether the flag (e.g., the flag 238) is set. Thus, requests in the queue may be taken out of turn in some instances.

As discussed herein, smart stream management policies can be implemented in streaming storage systems without impacting existing functionality. The flag 238 allows the system 200 to selectively perform operations in a predictive manner to reduce the impact of the stream management operations on storage or data ingestion operations.

As discussed previously, the requests placed in the workload aware queue 206 are subject to delayed execution, which is different from the requests placed in the stream management queue 204. This helps ensure that the workload aware queue 206 does not or is less likely to interfere with normal operation of the streaming storage system 201. Further, the time delayed or prediction-based execution of stream management operations can be coupled/decoupled to the system 201.

When implementing the workload aware queue 206, the controller 202 (or control plane) may be modified to integrate the model 208 as well or to integrate the system 200 as illustrated in FIG. 2.

In another example, the workload aware queue 206 and other predictive based components of the system 200 may alternatively be implemented as a service that intercepts client requests related to stream management, forwards the requests that require immediate executions, and keeps the requests subject to delayed execution based on the prediction of workload patterns generated by the model 208. In this example, the complexity regarding the workload aware queue 206 and the model 208 would reside on a separate service for easier development and simpler maintenance. A service can be integrated with multiple streaming storage services.

The type of model used as the model 208 may vary. Generally, models capable of receiving metrics and predicting a near future (e.g., minutes, hours, days, weeks). In some examples, models that are not subject to accuracy degradation are used. Thus, models such as Long Short-Terem Memory or ARIMA may be used for predicting workloads related to workloads that are influenced by human activity patterns.

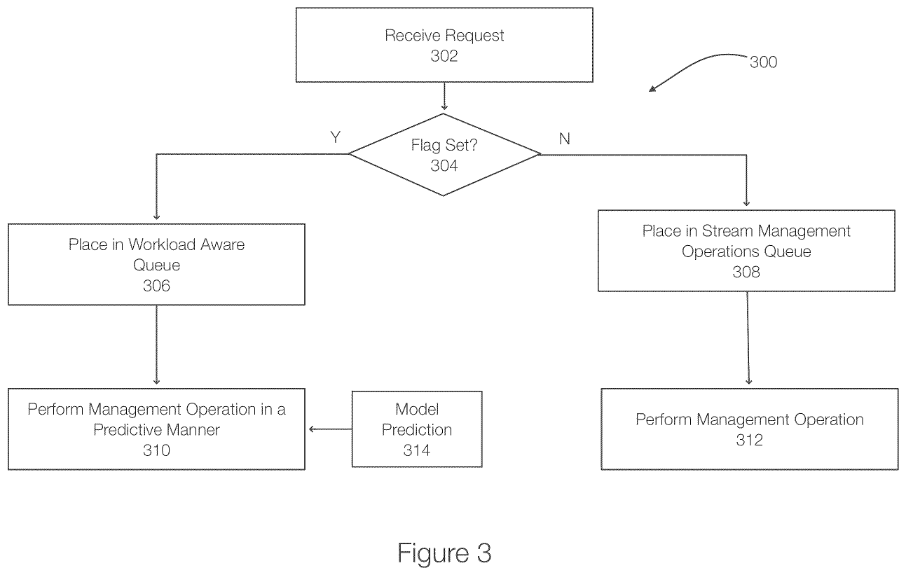

FIG. 3 discloses aspects of a method for performing prediction-based stream management operations. The method 300 may include receiving 302 a request from a client. The request 302 may specify a particular operation (e.g., delete, truncate, metadata update) to perform on data stored in the streaming storage system. The request may also include a flag indicating whether the operation is to be performed in delayed manner based on workload prediction. This allows a client to cause different streams to be handled in different manners.

The request is received at a server or at the streaming storage system. If the flag is set (Y at 304), the request is placed 306 in the workload aware queue 306. Management operations associated with the request are performed 310 based on a model prediction 314.

In one example, workload of the streaming storage system may be represented in some form such as a percentage. Over time, this allows the low workload and high workload percentages to be determined. In one example, a certain percentage is identified as a low percentage. When the current workload of the streaming storage system is predicted to be within some percentage points from the low percentage at a certain time period, the workload is scheduled for that time period.

If the flag is not set (N at 304), the request is placed 308 in the stream management operations queue and the management operation is performed 312 immediately or as soon as possible.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, stream management operations, time-delayed stream management operations, prediction based stream management operations, orchestration operations (orchestrating stream management operations), time-series prediction operations, stream ingestion operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, an edge system, an on-premise system, or the like, which is operable to perform operations initiated by one or more clients or other elements of the operating environment.

Example cloud computing environments, which may or may not be public, include storage environments that may provide functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Multimedia objects and other unstructured data may be examples of objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising:

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

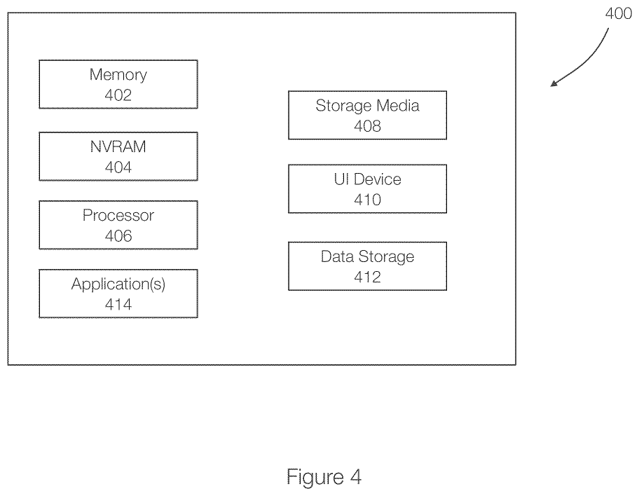

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods/operations illustrated in the Figures and described herein.

The device 400 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

1. A method comprising:
receiving a request from a client related to a stream management operation to be performed on streaming data stored in a streaming storage system, wherein the request includes a flag specifying whether or not the stream management operation is eligible for delayed execution;
placing the request in a workload aware queue in a case where the flag specifies that the stream management operation is eligible for the delayed execution;
generating a prediction by a model of a time period identifying a workload valley of the streaming storage system corresponding to a reduced ingestion activity; and
performing the stream management operation on the streaming data at the workload valley identified by the prediction in the case where the flag specifies that the stream management operation is eligible for the delayed execution.

2. (canceled)

3. The method of claim 1, wherein the request specifies a particular stream.

4. The method of claim 1, further comprising placing the request in a stream management operations queue in a case where the flag does not specify that the stream management operation is eligible for the delayed execution.

5. The method of claim 4, further comprising executing the stream management operation immediately or as soon as possible in the case where the flag does not specify that the stream management operation is eligible for the delayed execution.

6. The method of claim 1, further comprising receiving telemetry data of the streaming storage system into the model.

7. The method of claim 6, wherein the model is trained on historical telemetry data of the streaming storage system to learn workload patterns in the streaming storage system.

8. The method of claim 7, wherein the workload patterns include hourly patterns, daily patterns, and/or weekly patterns.

9. The method of claim 1, further comprising inputting currently available telemetry into the model such that the prediction is based on the currently available telemetry.

10. The method of claim 1, wherein the model and the workload aware queue are removably coupled to the streaming storage system.

11. A non-transitory storage medium having stored therein instructions that are executable by one or more hardware processors to perform operations comprising:
receiving a request from a client related to a stream management operation to be performed on streaming data stored in a streaming storage system, wherein the request includes a flag specifying whether or not the stream management operation is eligible for delayed execution;
placing the request in a workload aware queue in a case where the flag specifies that the stream management operation is eligible for the delayed execution;
generating a prediction by a model of a time period identifying a workload valley identified of the streaming storage system corresponding to a reduced ingestion activity; and
performing the stream management operation on the streaming data at the workload valley identified by the prediction in the case where the flag specifies that the stream management operation is eligible for the delayed execution.

12. (canceled)

13. The non-transitory storage medium of claim 11, wherein the request specifies a particular stream.

14. The non-transitory storage medium of claim 11, further comprising placing the request in a stream management operations queue in a case where the flag does not specify that the stream management operation is eligible for the delayed execution.

15. The non-transitory storage medium of claim 14, further comprising executing the stream management operation immediately or as soon as possible in the case where the flag does not specify that the stream management operation is eligible for the delayed execution.

16. The non-transitory storage medium of claim 11, further comprising receiving telemetry data of the streaming storage system into the model.

17. The non-transitory storage medium of claim 16, wherein the model is trained on historical telemetry data of the streaming storage system to learn workload patterns in the streaming storage system.

18. The non-transitory storage medium of claim 17, wherein the workload patterns include hourly patterns, daily patterns, and/or weekly patterns.

19. The non-transitory storage medium of claim 11, further comprising inputting currently available telemetry into the model such that the prediction is based on the currently available telemetry.

20. The non-transitory storage medium of claim 11, wherein the model and the workload aware queue are removably coupled to the streaming storage system.
